(19) United States
(12) Patent Application Publication
(10) Pub. No.: US 2007/0274720 A1
(43) Pub. Date: Nov. 29, 2007

(54) Optical Network Unit Activation

(76) Inventors: Heyward E. Menasco JR., Hoover, AL (US); Jack S. Swaim, Birmingham, AL (US); Dick L. Kwan, San Mateo, CA (US); James W. Fan, San Ramon, CA (US); Jacqueline L. Schaefer, Concord, CA (US)

Correspondence Address: D. Kent Stier;Merchant & Gould, PC, P.O. Box 2903, Minneapolis, MN, 55402-0903, US

(21) Appl. No.: 11/749,288

(22) Filed: May 16, 2007

Related U.S. Application Data
(60) Provisional application No. 60/808,583, filed on May 25, 2006.

(51) Int. Cl. H04J 14/00

(52) U.S. Cl. 398/66

(57) ABSTRACT

Optical network unit activation may be provided. First, an account may be associated with a port ID and a first ID. Next, activation data may be received including a serial number of a device and a received ID. Then, it may be determined that the data was received on a port corresponding to the port ID and that the received ID corresponds to the first ID. Next, in response to determining that the data was received on the port corresponding to the port ID and that the received ID corresponds to the first ID, the device may be activated to received at least one service associated with the account.

### RELATED APPLICATION

Under provision of 35 U.S.C. §119(e), Applicants claim the benefit of U.S. provisional application no. 60/808.583, filed May 25, 2006, which is incorporated herein by reference.

### BACKGROUND

An optical network unit (ONU) (also referred to as an optical network terminal (ONT) is a device placed, for example, at a customer premises to enable communications over optical fibers between the customer premises and a central office (CO). When a new or replacement ONU is connected through a fiber to an optical line terminal (OLT) at the CO, the OLT at the CO must be able to determine an OLT PON interface (port ID) and ONU_id to assign to the new or replacement ONU. In this way, the new or replacement ONU may be “activated” at the CO. Conventional methods defined in ITU G.984.3 provide two options (i.e. options A and B) for activating an ONU as described below.

With option A, an operator must pre-assign (pre-provision) an ONU serial number to an OLT port ID at the CO and with the ONU_id associated with the ONU. When the OLT at the CO discovers the new ONU on the OLT port ID and the ONU reports its serial number to the CO, the OLT receives a KNOWN serial number that is assigned to that OLT port ID and ONU_id. The OLT is able to activate the ONU on the assigned ONU_id and activate the ONU services. With option A, the ONU serial number must always be known in advance of the ONU installation. In other word, with option A, a service person cannot install any ONU that happens to be on the service person's vehicle. The service person must install a pre-provisioned ONU.

With option B, the serial number is not known in advance. With option B, the OLT assigns an unused ONU_id to the ONU and activates the ONU. A problem with option B is that the OLT is at liberty to select any available ONU_id on the port ID. If two or more new service orders were open on a same port ID, the OLT could assign any ONU_id to any of the two ONU. With Option B, it is not possible to provision specific customer services to an OLT port ID and ONU_id as the OLT controls which ONU get which ONU_id.

### SUMMARY

Consistent with embodiments of the present invention, systems and methods are disclosed for optical network unit activation. First, an account may be associated with an OLT port ID and a first ID. Next, activation data may be received including a serial number of a device and a received ID. Then, it may be determined that the date was received on a port corresponding to the OLT port ID and that the received ID corresponds to the first ID. Next, in response to determining that the data was received on the port corresponding to the port ID and that the received ID corresponds to the first ID, the device may be activated to receive at least one service associated with the account.

It is to be understood that both the foregoing general description and the following detailed description are examples and explanatory only, and should not be considered to restrict the invention's scope as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an optical network until activation system;

FIG. 2 is a block diagram of a processor;

FIG. 3 is a flow chart of a method for providing optical network unit activation; and

FIG. 4 is another flow chart of a method for providing optical network unit registration activation.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the invention.

Consistent with an embodiment of the invention, a new ONU installation process may be referred to as “option C”. Option C allows the ONU to be configured with, for example, a registration_id. The registration_id may comprise a 1 to 6 digit number that can be configured via a hardware switch, such as a dip switch, or may be entered via a test set, such as the touch tone pad on a technician's butt set. If entered via a test set touch tone pad, the registration_id may begin and end with a control digit, such as the #key (e.g., #123456#). Other control digits, such as the—key (e.g.), may be used to delete or reset registration_id in addition to a serial number of the ONU. The software at the CO will enable the OLT port ID and ONU_id to be pre-provisioned with an ONU's registration_id and customer specific services. Option C enables complete activation with all customer services without pre-provisioning the ONU's serial number. As the registration_id can be entered into the ONU by the service person, the service person is free, for example, to select any ONU on the service person's vehicle to install at the customer premise. To provide a security measure, a computer controlling the OLT will lock the ONU's serial number to a port ID and ONU_id once a valid registration_id is obtained on the OLT port ID. At this point, only that ONU serial number will be valid ONU until the serial number is manually unlocked in the computer controlling the OLT for maintenance process.

An embodiment consistent with the invention comprises a system for providing optical network unit activation. The system comprises a memory storage for maintaining a database and a processing unit coupled to the memory storage. The processing unit is operative to associate an account with a port ID and ONU_id and a first ID and to receive activation data including a serial number of a device and a received ID. In addition, the processing unit is operative to determine that the data was received on a port corresponding to the port ID and that the received ID corresponds to the first ID. Furthermore, the processing unit is operative to activate, in response to determining that the data was received on the port corresponding to the port ID and that the received ID corresponds to the first ID, the device to receive at least one service associated with the account.

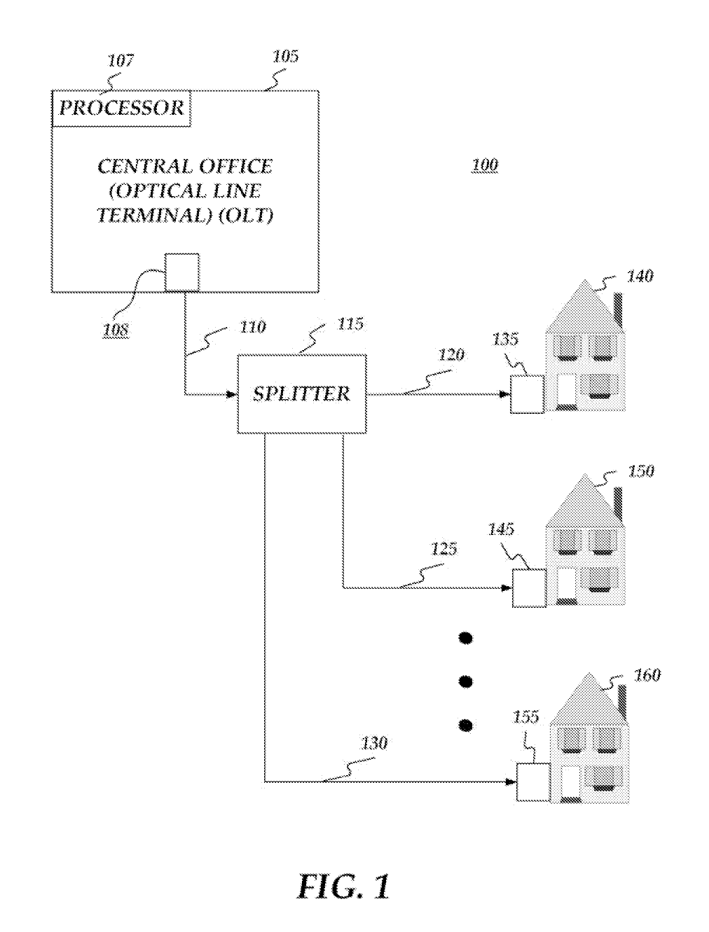

Consistent with an embodiment of the present invention, the aforementioned memory, processing unit, and other components may be implemented in a system, such as an exemplary optical network unit activation system 100 of FIG. 1. Any suitable combination of hardware, software, and/or firmware may be used to implement the memory, processing unit, or other components. By way of example, the memory, processing unit, or other components may be implemented with a processor 107, in combination with system 100. The aforementioned system and processor are exemplary and other systems and processors may comprise the aforementioned memory, processing unit, or other components, consistent with embodiments of the present invention.

Optical network unit registration activation may be provided. Consistent with embodiments of the present invention, FIG. 1 shows system 100 used in conjunction with a B-PON (Broadband Passive Optical Network), an E-PON (Ethernet Passive Optical Network), or a G-PON (Gigabit Passive Optical Network). As shown in FIG. 1, a central office having an OLT 105 communicates over optical fibers with first premises 140, second premises 150, and third premises 160. A main fiber 110 may provided enough bandwidth to provide service to a number of premises, for example, main fiber 110 may serve up to 32, or more premises. A splitter 115 may split main fiber 110's bandwidth between a first fiber 120, a second fiber 125, and a third fiber 130. First fiber 120 serves a first ONU 135 at first premises 140, second fiber 125 serves a second ONU 145 at second premises 150, and a third fiber 130 serves a third ONU 135 at third premises 160. Splitter 115 enables all of the data to flow in the opposite direction from the first fiber 120, the second fiber 130, the third fiber 140, and each additional fiber, to main fiber 110. Splitter 115 may be a passive optical device which is transparent to both the OLT and to each ONU. For example, ONT 135 and Fiber 120, serving customer premise 140, may be connected to any available port on splitter 115, with the exception of the splitter's main fiber 110 port.

A new ONU 135 may be placed at first premises 140. ONU 135 may be configured with, for example, a registration_id. The registration_id may comprise a 1 to 6 digit number that can be configured via a hardware switch, such as a dip switch, or may be entered via a test set, such as the touch tone pad on a service person's butt set. If entered into ONU 135 via a test set touch tone pad, the registration_id may begin and end with a control digit, such as the #key (e.g., #123456#). OLT 105 will be able to discover the registration_id for new ONU 135 in addition to a serial number of new ONU 135. The software in the computer at OLT 105 will enable an OLT port ID and ONU_id to be pre-provisioned with a new ONU 135's registration_id and customer specific services. The aforementioned OLT port ID and ONU_id identifies the main fiber 110 and the services assigned to first premise 140.

Consequently OLT port ID/ONU_id/registration_id may be completely activated with all customer services without pre-assigning the ONU's serial number. As the service person can enter the registration_id in ONU 135, the service person is free, for example, to select any ONU on the service person's vehicle to install on the customer premise as new ONU 135. To provide a measure of security, the software in a computer at OLT 105 will lock new ONU 135's serial number to the OLT port ID/ONU_id once a valid registration_id is obtained from new ONU 135 on OLT port ID 108. At this point, only that new ONU 135's serial number will be valid until ONU 135's serial number is manually unlocked for maintenance purposes, for example.

The Registration_ID is an authentication number, similar to a key or password, that can be pre-provisioned at OLT 105 and can be locally entered in ONUs such as first ONU 135. This process may use the Registration_ID only during initial ONU activation. Once the valid Registration_ID is discovered by OLT 105, OLT 105 correlates the Registration_ID to the provisioned Registration_ID and port ID and ONU_id, and then locks the discovered ONU serial number to the OLT port ID/ONU_id. After the OLT port ID/ONU_id and the ONU serial number are locked, all subsequent activation of the ONU (e.g., after a power loss, etc.) may be based on the serial number similar to ITU 984.3 ONU activation process Option A as described above. The process to lock the ONU serial number may be configured to occur automatically upon successful activation of the ONU. In another embodiment of this invention, the process to lock the ONU serial number may be configured to wait until a later point in time, such as configured by a timer, or when the OLT receives an order completion notification from some other operation support system. So long as the OLT port ID/ONU_id is unlocked and inactive, the OLT will activate an ONU that sends a first ID which correlates to the unlocked, inactive OLT port ID/ONU_id/first ID and the ONU serial is not already locked to another port ID/ONU_id on the same OLT.

However, should first ONU 135 need to be replaced and ONU 135 OLT port ID/ONU_id/Serial number is locked, the ONU serial number must be unlocked at OLT 105. The OLT 105 will continue to maintain service on the unlocked ONU unless the ONU fails or is disconnected. The OLT should retain the ONU serial number until the ONU becomes out of service and a new ONU sends the OLT a first ID which matches the first ID of the unlocked OLT port ID/ONU_id. Once OLT correlates OLT port ID/ONU_id/first ID of the new ONU, the OLT will lock the new ONU serial number, using the same process described above for activation of a new ONU. The process of locking and unlocking the registration_ID process is also optional. If the locking mechanism is not used, then anytime the ONU serial number is disconnected or disabled, a replacement ONU with a matching registration_ID may be activated.

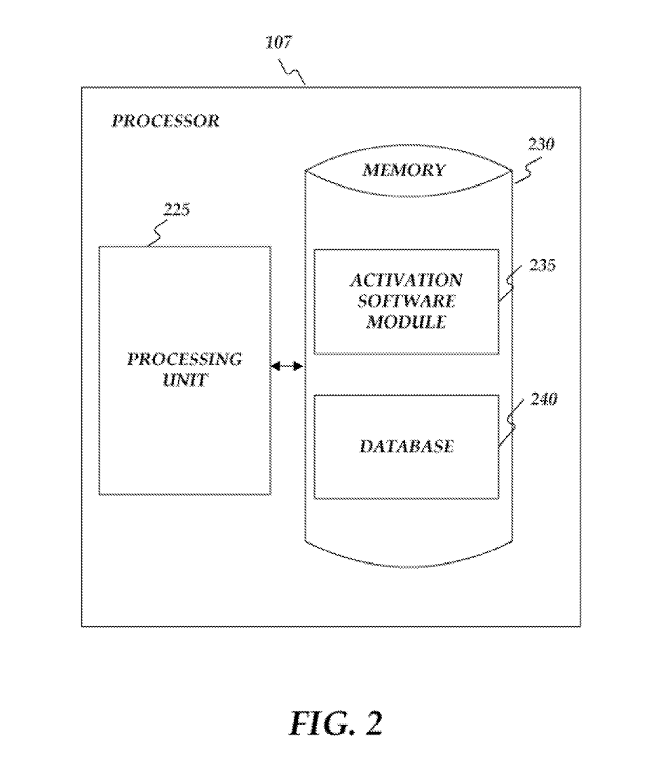

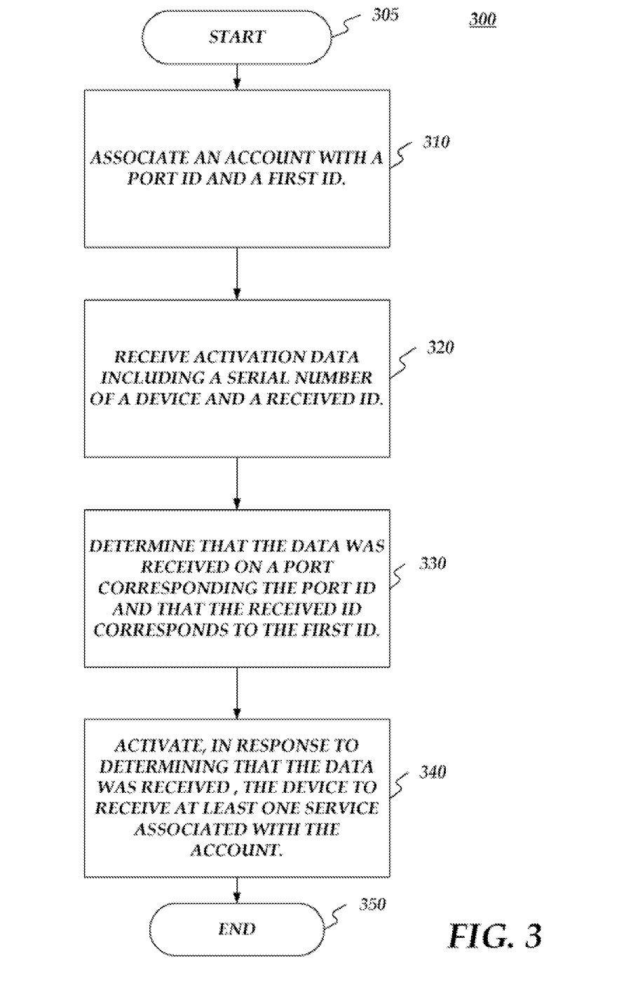

FIG. 2 shows processor 107 of FIG. 1 in more detail. As shown in FIG. 2, processor 107 may include a processing unit 225 and a memory 230. Memory 230 may include an activation software module 235 and a memory 230. Memory 230 may include an activation software module 235 and a database 240. While executing on processing unit 225, activation software module 235 may perform processes for providing optical network unit activation, including, for example, one or more of the stages of method 300 described below with respect to FIG. 3.

Processor 107 (“the processor”) included in system 100 may be implemented using a central processor unit (CPU), personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

FIG. 3 is a flow chart setting forth the general stages involved in a method 300 consistent with an embodiment of the invention for providing optical network unit activation. Method 300 may be implemented using processor 107 as described in more detail above with respect to FIG. 2. Ways to implement the stages of method 300 will be described in greater detail below. Method 300 may begin at starting block 305 and proceed to stage 310 where processor 107 may associate an account with an OLT port ID/ONU_id and a first ID. The port ID may correspond to main filter 110 and the first ID corresponds to the OLT port ID/ONU_id. The ONU_id is the logical which correlates to each ONU (e.g., ONU 135) connected to the port ID 108. The OLT port ID/ONU_id may be pre-provisioned with the ONU first ID and services that correspond to the subscriber's account. The subscriber's account correspond to a customer premise (e.g., customer premise 140). For example, a user may have an account with a service provider who provides communications services to the user. Processor 107 may have stored in database 240 a record corresponding to the user. This record may contain the types of services the user is to receive along with the OLT port ID/ONU_id and the first ID corresponding to the user's account.

With respect to the OLT port ID, for example, there is a port 108 on CO OLT 105 that has one fiber (i.e. main fiber 110) that goes from the CO out to the field Main Fiber 110 may split up to 32, or more different ways where each of the 32 splits may serve an ONU. The number of splits per main fiber is an engineering design decision. As shown in FIG. 1, these splits may comprise first fiber 120, second fiber 125, and third fiber 130, for example. Consequently, database 240 may include data indicating which physical port 108 first fiber 120, second fiber 125, and third fiber 130 are coming in at OLT 105. However, database 240 may not yet include data indicating which ONU 35 serial number will be installed at Customer Premise 140 that corresponds to fiber 120, splitter 115, main fiber 110, OLT port 108 and OLT 107. Consequently, an additional attribute (i.e. first ID) may be added when provisioning a new ONU (e.g. new ONU 135) on one of the OLT port ID/ONU_ID. Consequently, when a new ONU is provisioned, processor 107 may then provision the user's services or telephone line, data services, TV services, etc.

From stage 310, where processor 107 associates the account with the OLT port ID/ONU_id and the first ID, method 300 may advance to stage 320 where processor 107 may receive activation data including a serial number of a device and a received ID. The device may comprise an ONU (e.g. new ONU 135). For example, when a new ONU (e.g. new ONU 135) is installed, a technician installing the new ONU may enter the first ID as part of a “turn up” process. Consequently, when that ONU comes up online, it sends both the first ID and its serial number. Processor 107 may receive the first ID and the serial number from this ONU.

One processor 107 receives the activation data including the serial number of the device and the received ID in stage 320, method 300 may continue to stage 330 where processor 107 may determine that the data was received on a port on OLT 105 corresponding the OLT port ID 108 and that the received ID corresponds to a first ID on the same port ID. Consequently, processor 107 may associate the ONU serial number with the account in database 240. For example, because the aforementioned ONU is new, OLT 105 does not recognize the new ONU's serial number. Processor 107 locks at the received first ID and determines if it is valid for the OLT port ID/ONU_id. If it is valid, then processor 107 determines it has a valid first ID, thus the received ONU serial number may be accepted.

After processor 107 determines that the data was received on a port corresponding to the OLT port ID and that the received ID corresponds to the first ID of the OLT port ID/ONU_id in stage 330, method 300 may proceed to stage 340 where processor 107 may activate, in response to determining that the data was receive, the device to receive at least one service associated with the account. For example, processor 107 may activate new ONU 135. Subsequently, processor 107 may then lock in the received ONU 135 serial number. Accordingly, processor 107 may not accept any other serial number for that logical ONU unless it is unlocked from that point. One processor 107 activates the device the device in stage 340, method 300 may then end at stage 350.

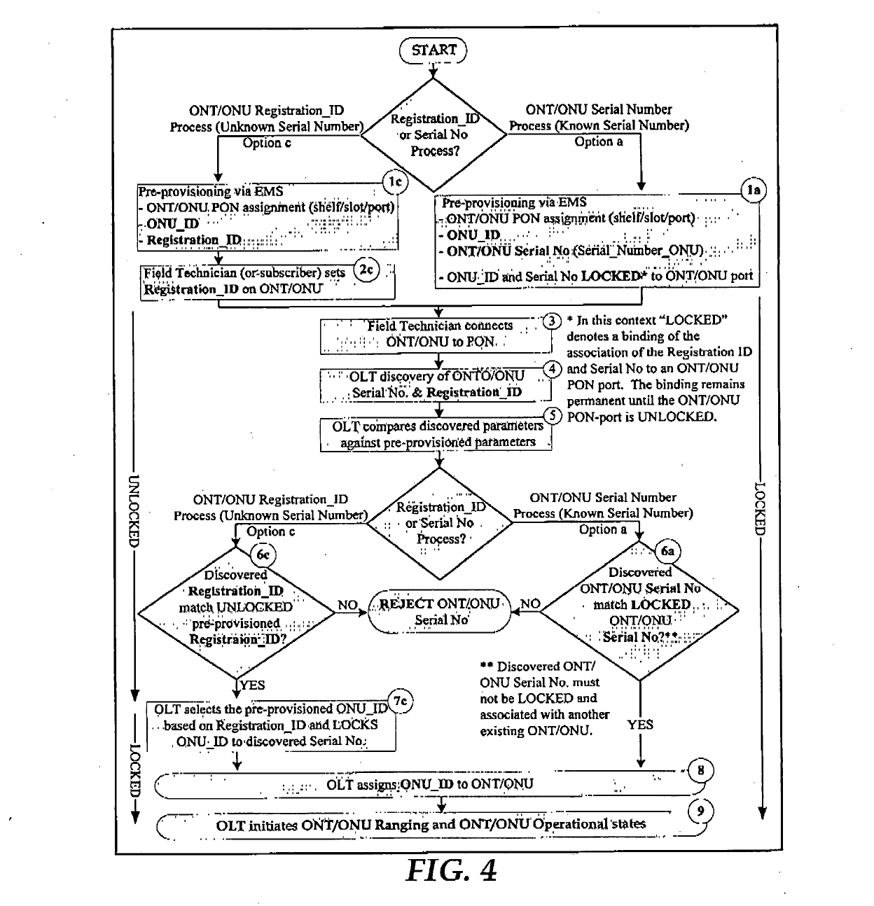

Consistent with an embodiment of the invention, FIG. 4 shows an “option C” enabling an ONU with an unknown serial number to be installed and then registered with the CO. (FIG. 4 shows option C with “c” designations.) A security check mechanism may be used to ensure that whoever is installing the ONU is a legitimate installer and eliminate the possibility of fraud. Embodiments of the invention may also ensure that the installation process could accommodate a situation where an installer (e.g. a service person) is installing two ONUs on the same OLT port ID and have check mechanisms to ensure the right service order (e.g. the installer could get orders mixed up) is completed at the right Customer Premise. This concern may add extra complexity just to prevent a possible installer error.

The aforementioned security mechanism may involve a service technician person entering a code into the ONU during installation. Consistent with embodiments of the invention, an ONU_id itself could serve as this control ID mechanism. The OLT port ID/ONU_id would be pre-provisioned in the CO (i.e. OLT)) and the service person installing the ONU would need to know this ONU_id number in order to enter it into the ONU. However, a simple ONU_id number may be insufficient due to the possibility of installers getting orders mixed up. Consistent with another embodiment of the invention, the technician may be allowed to enter both the ONU_id and a security code or to enter control ID before the ONU would activate.

Consistent with embodiments of the invention, pre-provisioning a “registration_ID” in the OLT port ID/ONU_id and having the technician enter this registration_ID during ONU installation via, for example, a butt set may be used. Upon a successful match of the OLT port ID/ONU_id and first ID, the ONU_id would be associated with the ONU serial number. The registration_ID may be retained at the CO, but would not be used on an ongoing basis once the ONU_id is associated with the ONU serial number. In other words, if there was a power failure, the CO would have retained the association between the ONU serial number and ONU_id and allow the ONU to activate without any manual intervention required.

The registration_ID code may be up to 6 digits in length to be preceded and followed by a control character such as #. Furthermore, it may not be necessary for the registration_ID to be very long. For example, this identifier could be a service order number, a subset of the service order number or some other identifier associated with the service order. Different service providers may have different requirements for the service order number and there could be flexibility to allow an operator to decide the number of characters in the registration_ID. The registration_ID may be flexible enough to actually be the ONU_ID itself if the service provider desired this. This, for example, would allow fewer digits to be entered by the technician.

Consistent with an embodiment of the invention, with option C, the ONU_id may be assigned during the service order process and be assigned in advance of the physical ONU installation. The G984.3 standard has message Assign_ONU_ID to enact the pre-provisioning of the ONU_id against an ONU to be installed to a PON. The Assign_ONU_ID message has provision in the G984.3 standard for Octets 4-11 to contain the ONU serial number would not be known when the ONU_id is assigned.

Consistent with an embodiment of the invention, a locking mechanism may be used so that once an ONU is installed and activated, the ONU_id may be locked against a specific ONU serial number. The lock feature may ensure, for example, that the registration function is only required at initial turn-up and upon a power failure allows the ONU to re-range and re-activate successfully based on the locked ONU serial number. For maintenance purposes, the ONU_id may be changed from the locked state to the unlocked state. At that point, the current ONU serial number will continue to function, unless the ONU fails or is disconnected. The current ONU serial number shall be retained until the current ONU is out of service and a new ONU sends a first ID which correlates to the OLT port ID/ONU_id in the unlocked state. Then, the OLT will activate the new ONU and insert the new ONU serial number into the OLT port id/ONU_id data. For ONU replacement, the service person would disconnect the current ONU, enter the registration_{—ID (as was done for the initial ONU) in the replacement ONU, and install the new ONU. The CO (OLT) would recognize the registration}_ID and then associate and lock the pre-associated ONU_id against the discovered ONU serial number and allow ranging activation to occur.

Generally, consistent with embodiments of the invention program modules may include routines, programs, components, data structure, and other types of structures that may perform particular, components, data structure, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communication network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.) In other words, embodiments of the present invention may take the form of a computer program product on a computer-usable or computer-readable storage medium having computer-usable or computer-usable or computer-readable storage medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The function/acts noted in the blocks may occur out of the order as shown in any flowchart. For example, two block shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, date can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

What is claimed is:

1. A method for providing activation, the method comprising:
associating an account with a port ID and a first ID;
receiving activation data including a serial number of a device and a received ID;
determining that the data was received on a port corresponding to the port ID and that the received ID corresponds to the first ID; and
activating, in response to determining that the data was received on the port corresponding to the port ID and that the received ID corresponds to the first ID, the device to receive at least one service associated with the account.

2. The method of claim 1, further comprising associating the serial number with the account.

3. The method of claim 1, further comprising associating an ONU_with the port ID and first ID.

4. The method of claim 3, further comprising enabling a different serial number to activate during an unlocked state if the serial number on the account is not activated.

5. The method of claim 3, further comprising locking the serial number to the port ID and ONU_id upon receipt of a valid first ID and a valid ONU serial number.

6. The method of claim 5, further comprising receiving locking data from an operations support system following completing of a service order.

7. The method of claim 5, further comprising receiving locking data immediately following activation of the device.

8. The method of claim 5, further comprising receiving locking data following the expiration of a configurable timer that starts at device activation.

9. The method of claim 1, further comprising the serial number to be associated with the account until unlocking data is received configured to indicate a user initiated command to disassociate the serial number with the account.

10. The method of claim 9, further comprising retaining the serial number, the serial number being active until one of the device fails and becomes out of service and a new serial number with a valid first ID is activated.

11. The method of claim 9, further comprising denying activation of a new serial number and valid first ID so long as the serial number is in the activated state.

12. The method of claim 1, wherein associated the account with the port ID and the first ID comprises associated the account corresponding to data services.

13. The method of claim 1, wherein associating the account with the port ID and the first ID comprises associating the account with the port ID corresponding to a main optical fiber.

14. The method of claim 1, wherein associating the account with the port ID and the first ID comprises associating the first ID with a sub optical fiber being split off of a main optical fiber associated with the port ID.

15. The method of claim 1, wherein receiving the activation data including the serial number of the device and the received ID comprises receiving the activation data including the serial number of the device comprising an optical network device.

16. The method of claim 1, wherein receiving the activation data comprises receiving the activation from the device.

17. The method of claim 1, wherein receiving the activation data comprises receiving the activation data in response to the device being installed on a network.

18. The method of claim 1, wherein receiving the activation data comprises receiving the activation data from the device in response to the device being installed on a network, the received ID being entered into the device by a technician installing the device.

19. A computer-readable medium which stores a set of instructions which when executed performs a method for providing network unit activation, the method executed by the set of instruction comprising:
associating an account with a port ID and a first ID;
receiving activation data including a serial number of a device and received ID;
determining that the data was received on a port corresponding to the port ID and that the received ID corresponds to the first ID;
activating, in response to determining that the data was received on the port corresponding to the port ID and that the received ID corresponds to the first ID, the device to receive at least one service associated with the account; and
associating and locking the serial number with the account, the serial number configured to be associated with the account until unlocking data is received configured to indicate a user initiated command to unlock the serial number with the account.

20. The computer-readable medium of claim 19, wherein associating the account with the port ID and first Id comprises associating the account corresponding to data services.

21. The computer-readable medium of claim 19, wherein associating the account with the port ID and the first ID comprises associating the account with the port ID corresponding to a main optical fiber.

22. The computer-readable medium of claim 19, wherein associating the account with the port ID and the first ID comprises associating the first ID with a sub optical fiber being split off a main optical fiber associated with the port ID.

23. The computer-readable medium of claim 19, wherein receiving the activation data including the serial number of the device and the received ID comprises receiving the activation data including the serial number of the device comprising an optical network device.

24. The computer-readable medium of claim 19, wherein receiving the activation data comprises receiving the activation data from the device.

25. The computer-readable medium of claim 19, wherein receiving the activation data comprises receiving the activation data in response to the device being installed on a network.

26. The computer-readable medium of claim 19, wherein receiving the activation data comprises receiving the activation data from the device in response to the device being installed on a network, the received ID being entered into the device by a technician installing the device.

27. A system for providing network unit activation, the system comprising:
a memory storage; and
a processing unit coupled to the memory storage, wherein the processing unit is operative to:
associate an account with a port ID and a first ID;
receive, in response to a device being installed on a network, activation data including a serial number of the device and a received ID;
determine that the data was received on a port corresponding to the port ID and that the received ID corresponds to the first ID;
activate, in response to determining that the data was received on the port corresponding to the port ID and that the received ID corresponds to the first ID, the device to receive at least one service associated with the account; and
associate and lock the serial number with the account, the serial number configured to be associated with the account until unlocking data is received configured to indicate a user initiated command to unlock the serial number with the account.

28. The system of claim 27, wherein processing unit being operative to receive the activation data comprises the processing unit being operative to receive the activation data from the device wherein the received ID is entered into the device by a technician installing the device.
